(19) United States
(12) Patent Application Publication
(10) Pub. No.: US 2015/0117868 A1
(43) Pub. Date: Apr. 30, 2015

(54) PARALLEL OPTICAL TRANSMITTER

(71) Applicant: Avago Technologies General IP (Singapore) Pte. Ltd., Singapore (SG)

(72) Inventors: Giammarco Rossi, Torino (IT); Ruiyu Fang, Torino (IT); Roberto Paoletti, Torino (IT)

(73) Assignee: Avago Technologies General IP (Singapore) Pte. Ltd., Singapore (SG)

(21) Appl. No.: 14/066,886

(22) Filed: Oct. 30, 2013

(51) Int. Cl. H04B 10/50; G02F 1/17; G02F 1/225; G02B 6/12

(52) U.S. Cl. CPC H04B 10/5053; G02B 6/12; G02F 1/17; G02F 1/2257; G02B 2006/12142; G02B 2006/1215; G02B 2006/1209; G02B 2006/12147; G02F 2001/212
USPC 398/183

(57) ABSTRACT

An N-channel parallel optical transmitter includes a dual-facet continuous-wave laser, two or more optical splitters, and four or more optical modulators. One of the optical splitters has an input coupled to the first facet of the laser, and another has an input coupled to the second facet of the laser. The outputs of the splitters are coupled to the inputs of the optical modulators.

### BACKGROUND

In an optical communication system, an optical transmitter can convert electrical signals that are modulated with information into optical signals for transmission via an optical fiber. A light source such as a laser performs the electrical-to-optical signal conversion in an optical transmitter. An optical receiver can receive the optical signals via the optical fiber and recover the information by demodulating the optical signals. A light detector such as a photodiode performs the optical-to-electrical signal conversion in an optical receiver.

Optical communication systems in which two or more channels operate in parallel with each other are known as parallel optical communication systems. A parallel optical communication system can comprise a parallel optical transmitter and a parallel optical receiver. Various types of parallel optical transmitters and receivers are known.

As illustrated in FIG. 1, one type of parallel optical transmitter 100 comprises multiple light sources (“L”) 102, 104, 106, 108, etc., such as lasers, which can be directly modulated. Although four light sources are shown in FIG. 1 for purposes of illustration, such a parallel optical transmitter can comprise more or fewer light sources. Light sources 102-108, etc., are commonly formed on the same monolithic semiconductor chip as each other. Each of light sources 102-108, etc., receives an electrical signal that has been modulated with information and converts the electrical signal into an optical signal. Each of light sources 102-108, etc., outputs a modulated optical signal representing a communication channel.

As illustrated in FIG. 2, another type of parallel optical transmitter 200 comprises multiple light sources (“L”) 202, 204, 206, 208, etc., such as lasers. Although four light sources are shown in FIG. 2 for purposes of illustration, such a parallel optical transmitter can comprise more or fewer light sources. Each of light sources 202-208, etc., produces an unmodulated or continuous-wave (CW) beam. Each CW beam is provided as an input to a corresponding optical modulator (“M”) 210, 212, 214, 216, etc., via an optical connection such as an optical fiber or a waveguide. Light sources 202-208, etc., are commonly formed on the same monolithic semiconductor chip as each other. Modulators 210-216, etc., may be formed on the same semiconductor chip as light sources 202-208, etc., or may formed on a separate chip. Each of modulators 210-216, etc., also receives as an input (indicated by an arrow in FIG. 2) an electrical signal that has been modulated with information. Each of modulators 210-216, etc., may be, for example, an electro-absorption modulator or a Mach-Zehnder modulator. Each of modulators 210-216, etc., operates by modulating the CW beam it receives with the information represented by the electrical signal it receives. Each of modulators 210-216, etc., outputs a modulated optical signal representing a communication channel.

As illustrated in FIG. 3, still another type of parallel optical transmitter 300 comprises multiple light sources 302, 304, 306, 308, etc., such as lasers. Although four light sources are shown in FIG. 3 for purposes of illustration, such a parallel optical transmitter can comprise more or fewer light sources. Each of light sources 302-308, etc., produces a CW beam. Light sources 202-208, etc., are formed on the same monolithic semiconductor chip as each other and directly coupled to corresponding modulators 310, 312, 314, 316, etc., formed on the same chip. Each of modulators 310-316, etc., may be, for example, an electro-absorption modulator or a Mach-Zehnder modulator. Each of modulators 310-316, etc., also receives as an input (indicated by an arrow in FIG. 3) an electrical signal that has been modulated with information. Each of modulators 310-316, etc., operates by modulating the CW beam it receives with the information represented by the electrical signal it receives. Each of modulators 310-316, etc., outputs a modulated optical signal representing a communication channel.

As illustrated in FIG. 4, yet another type of parallel optical transmitter 400 comprises a single light source 402, such as a laser, which produces a CW beam having a power P. Parallel optical transmitter 400 further comprises an optical splitter 404 and multiple modulators 406, 408, 410, 412, etc. Although splitter 404 has a 1-to-4 splitting ratio, such a splitter can more generally have a 1-to-N splitting ratio, where N is an integer greater than one. A splitter having a 1-to-N splitting ratio can comprise, for example, a multimode interference coupler. The outputs of splitter 404 are coupled to the inputs of modulators 406-412, etc. Thus, each of modulators 406-412, etc., receives as an input a CW beam having an optical power of P/N. Each of modulators 406-412, etc., also receives as an input (indicated by an arrow in FIG. 4) an electrical signal that has been modulated with information. Each of modulators 406-412, etc., may be, for example, an electro-absorption modulator or a Mach-Zehnder modulator. Each of modulators 406-412, etc., operates by modulating the CW beam it receives with the information represented by the electrical signal it receives. Each of modulators 406-412, etc., outputs a modulated optical signal representing a communication channel.

Light source 402, such as a laser, is commonly formed on a separate semiconductor chip from modulators 406-412 and splitter 404 because lasers are more commonly fabricated on indium phosphide (InP) substrates while modulators and splitters are more commonly fabricated on silicon (Si) substrates. Nevertheless, it is known to integrate light source 402, modulators 406-412 and splitter 404 on the same InP substrate. However, in such an integrated or monolithic implementation light source 402 and splitter 404 must be aligned with the waveguide 414 with great precision, which is difficult to achieve without complex or laborious manufacturing processes. If transmitter 400 were fabricated in quantities on the orders of magnitude common in semiconductor wafer fabrication, wafer yield would be very low. Consequently, such integrated, monolithic implementations of transmitter 400 have not been commercially feasible.

A light source that comprises a laser may have two facets, commonly referred to as a “front” facet and a “rear” facet, each of which is capable of outputting a beam. Such a laser may be referred to as a dual-facet laser. In an optical transmitter, the front facet commonly provides the optical signals described above. The rear facet is commonly used to provide a feedback optical signal to a monitor photodiode or other detector (not shown). The monitor photodiode converts the feedback optical signal into an electrical signal that is used as feedback by a control circuit that adjusts the power of the laser to maintain it at a nominal value.

In an optical transmitter having a feedback control circuit, the power distribution between the front facet and rear facet of the laser is commonly unbalanced. That is, the laser is configured so that the front facet outputs a much greater percentage of the total optical power (P) than the rear facet. In an unbalanced dual-facet laser, the front facet commonly outputs five or more times the power of the rear facet. Fabrication processes for unbalanced lasers of this type commonly have low yield. Consequently, practitioners in the art have sought alternatives to dual-facet lasers whenever feasible.

### SUMMARY

Embodiments of the present invention relate to a parallel optical transmitter. In an exemplary embodiment, the parallel optical transmitter comprises: a dual-facet continuous-wave laser having a first facet output and a second facet output; a first optical splitter having an input coupled to the first facet output; a second optical splitter having an input coupled to the second facet output; a first optical modulator having an electrical input and having an optical input coupled to a first output of the first optical splitter; a second optical modulator having an electrical input and having an optical input coupled to a second output of the first optical splitter; a third optical modulator having an electrical input and having an optical input coupled to a first output of the second optical splitter; and a fourth optical modulator having an electrical input and having an optical input coupled to a second output of the second optical splitter.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a block diagram of a first optical transmitter, in accordance with the prior art.

FIG. 2 is a block diagram of a second optical transmitter, in accordance with the prior art.

FIG. 3 is a block diagram of a third optical transmitter, in accordance with the prior art.

FIG. 4 is a block diagram of a fourth optical transmitter, in accordance with the prior art.

FIG. 5 is a block diagram of an optical transmitter, in accordance with an exemplary embodiment of the invention.

FIG. 6 is a block diagram of an optical transmitter, in accordance with another exemplary embodiment of the invention.

FIG. 7 is a block diagram of an optical transmitter, in accordance with still another exemplary embodiment of the invention.

FIG. 8 is a generalized top plan view of a semiconductor wafer having a multiplicity of optical transmitters formed thereon.

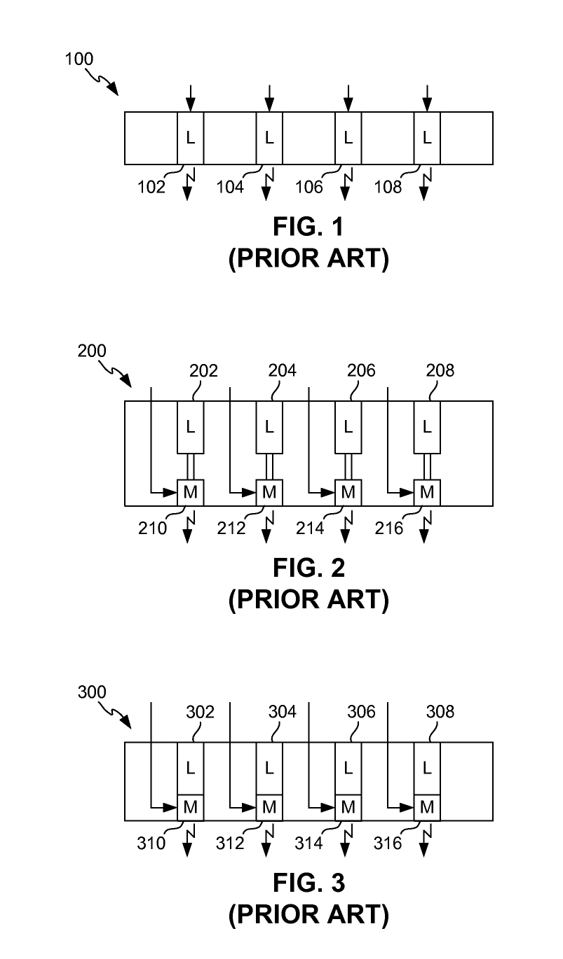

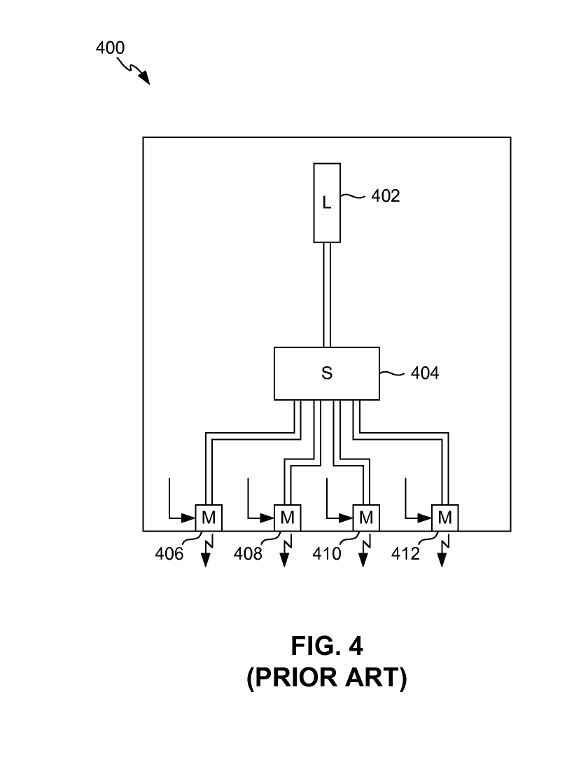

### DETAILED DESCRIPTION

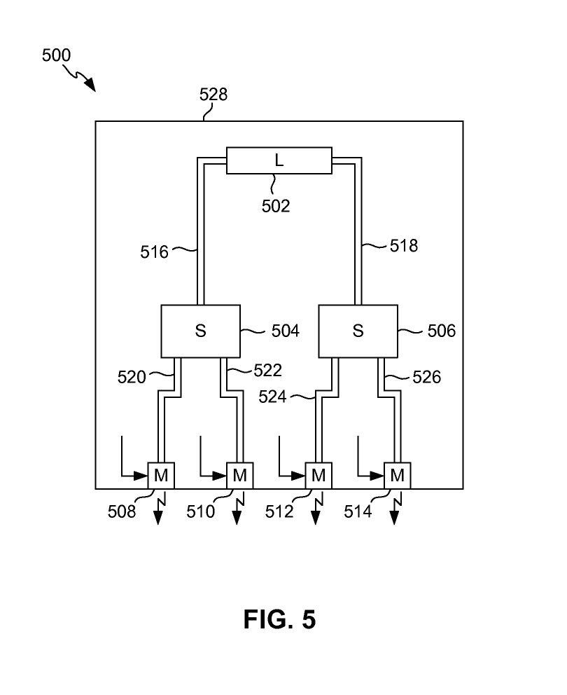

As illustrated in FIG. 5, in an illustrative or exemplary embodiment of the invention, a parallel optical transmitter 500 includes a dual-facet continuous-wave (CW) laser 502, a first optical splitter 504, a second optical splitter 506, a first optical modulator 508, a second optical modulator 510, a third optical modulator 512, and a fourth optical modulator 514. Laser 502 has a first facet and a second facet that respectively provide optical outputs to waveguides 516 and 518. First optical splitter 504 has an input coupled to the first facet via waveguide 516. Second optical splitter 506 has an input coupled to the second facet via waveguide 518. Each of optical modulators 508-514 has an electrical input (indicated by an arrow) and an optical input. The optical input of first optical modulator 508 is coupled to a first output of first optical splitter 504 via a waveguide 520. The optical input of second optical modulator 510 is coupled to a second output of first optical splitter 504 via a waveguide 522. The optical input of third optical modulator 512 is coupled to a first output of second optical splitter 506 via a waveguide 524. The optical input of fourth optical modulator 514 is coupled to a second output of second optical splitter 506 via a waveguide 526. Laser 502, optical splitters 504 and 506, optical modulators 508-514 and waveguides 516-526 can be integrated on a monolithic semiconductor substrate 528, such as InP.

Laser 502 is substantially balanced. That is, laser 502 is configured such that its first and second facets emit beams of substantially equal optical power. Although it is preferable that the first and second facets emit exactly equal optical power, such precise balance is rarely achievable due to fabrication tolerances. Therefore, for purposes of this disclosure, two facets emit “substantially equal” optical power if the ratio of their emitted optical powers is in the range of 0.5 to 2.0. Fabrication processes for substantially balanced dual-facet lasers can have much greater yield than fabrication processes for unbalanced dual-facet lasers. Accordingly, a fabrication process for transmitter 500, in which such a laser 502 is integrated on substrate 528 with optical splitters 504 and 506, optical modulators 508-514 and waveguides 516-526, can have a surprisingly high yield and therefore be commercially useful.

Each of first and second optical splitters 504 and 506 has a splitting ratio of 1-to-2. Thus, each of optical splitters 504 and 506 receives a beam having a CW power P, where laser 502 has a total power of 2 P. Each output of each of optical splitters 504 and 506 provides a beam having a power P/2. Each of optical modulators 508-514 modulates one such beam with the information represented by the electrical signal it receives. Modulators 508-514 can be, for example, electro-absorption modulators or Mach-Zehnder modulators.

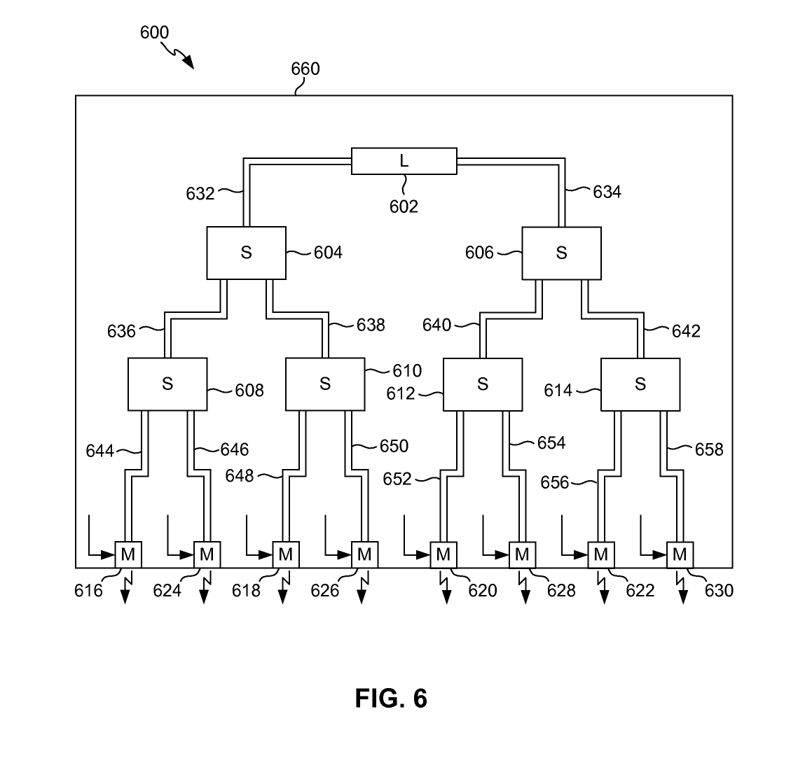

As illustrated in FIG. 6, in another illustrative or exemplary embodiment of the invention, a parallel optical transmitter 600 includes a substantially balanced, dual-facet, CW laser 602, a first optical splitter 604, a second optical splitter 606, a third optical splitter 608, a fourth optical splitter 610, a fifth optical splitter 612, a sixth optical splitter 614, a first optical modulator 616, a second optical modulator 618, a third optical modulator 620, and a fourth optical modulator 622, a fifth optical modulator 624, a sixth optical modulator 626, a seventh optical modulator 628, and an eighth optical modulator 630. Laser 602 has a first facet and a second facet that respectively provide optical outputs to waveguides 632 and 634. The input of first optical splitter 604 is coupled to the first facet via waveguide 632. The input of second optical splitter 606 is coupled to the second facet via waveguide 634. The input of third optical splitter 608 is coupled to a first output of first optical splitter 604 via a waveguide 636. The input of fourth optical splitter 610 is coupled to a second output of first optical splitter 604 via a waveguide 638. The input of fifth optical splitter 612 is coupled to a first output of second optical splitter 606 via a waveguide 640. The input of sixth optical splitter 614 is coupled to a second output of second optical splitter 606 via a waveguide 642. Each of first through sixth optical splitters 604-614 has a splitting ratio of 1-to-2.

Each of optical modulators 616-630 has an electrical input (indicated by an arrow) and an optical input. The optical input of first optical modulator 616 is coupled to a first output of third optical splitter 608 via a waveguide 644 (and thus also indirectly coupled to the first output of first splitter 604). The optical input of second optical modulator 618 is coupled to a first output of fourth optical splitter 610 via a waveguide 648 (and thus also indirectly coupled to the second output of first optical splitter 604). The optical input of third optical modulator 620 is coupled to a first output of fifth optical splitter 612 via a waveguide 652 (and thus also indirectly coupled to the first output of second optical splitter 606. The optical input of fourth optical modulator 622 is coupled to a first output of sixth optical splitter 614 via a waveguide 656 (and thus also indirectly coupled to the second output of second optical splitter 606). The optical input of fifth optical modulator 624 is coupled to a second output of third optical splitter 608 via a waveguide 646. The optical input of sixth optical modulator 626 is coupled to a second output of fourth optical splitter 610 via a waveguide 650. The optical input of seventh optical modulator 628 is coupled to a second output of fifth optical splitter 612 via a waveguide 654. The optical input of eighth optical modulator 630 is coupled to a second output of sixth optical splitter 614 via a waveguide 658. Laser 602, optical splitters 604-614, optical modulators 616-630 and waveguides 632-658 can be integrated on a monolithic semiconductor substrate 660, such as InP. Modulators 616-630 can be, for example, electro-absorption modulators or Mach-Zehnder modulators.

From the exemplary embodiments described above with regard to FIGS. 5 and 6, it can be appreciated that embodiments can more generally be characterized as having N channels, where N is a power of two greater than or equal to four. Embodiments can further be characterized as having N optical modulators of the type described above and N−2 optical splitters of the type described above. The optical splitters are arranged in a binary tree configuration. That is, each optical splitter has exactly (i.e., no more than and no less than) one optical input, exactly two optical outputs, and a splitting ratio of 1-to-2. The highest level of the binary tree configuration is characterized by one of the N−2 optical splitters having an input coupled to the first facet of the laser, and another of the N−2 optical splitters having an input coupled to the second facet of the laser. The lower one or more levels of the binary tree configuration are characterized by the inputs of the remainder of the optical splitters being coupled to outputs of other optical splitters. The lowest level of the tree is characterized by optical splitters having outputs coupled to inputs of the optical modulators.

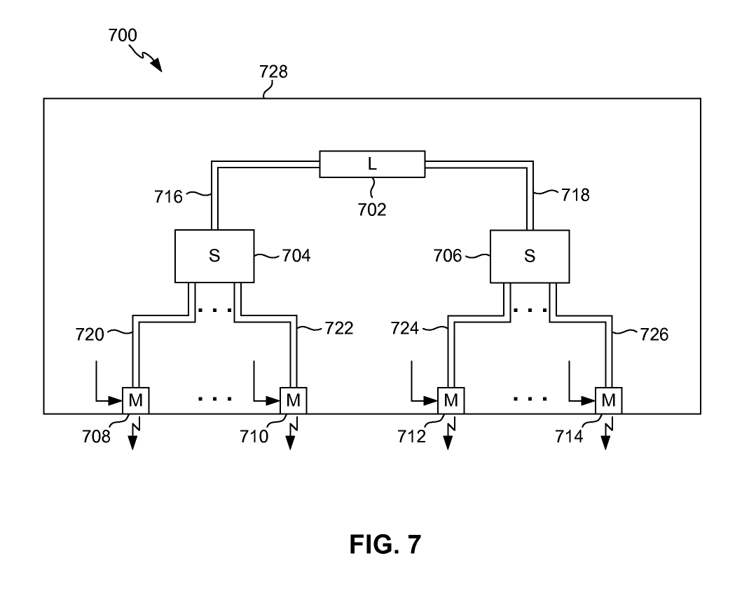

As illustrated in FIG. 7, embodiments also can have any even number N of channels, where N is greater than or equal to four. In accordance with such embodiments, a parallel optical transmitter 700 includes a substantially balanced, dual-facet CW laser 702, a first optical splitter 704 that splits an optical signal into N/2 optical signals (i.e., has a splitting ratio of 1-to-N/2), a second optical splitter 706 that splits an optical signal into N/2 optical signals, a first group of N/2 optical modulators 708 through 710, and a second group of optical modulators 712 through 714. Laser 702 has a first facet and a second facet that respectively provide optical outputs to waveguides 716 and 718. First optical splitter 704 has an input coupled to the first facet via waveguide 716. Second optical splitter 706 has an input coupled to the second facet via waveguide 718.

Each of the N/2 optical modulators 708-710 in the first group is coupled to one of a first through an (N/2)th output of first optical splitter 704 via a respective one of N/2 waveguides 720-722. Each of the N/2 optical modulators 712-714 in the second group is coupled to one of a first through an (N/2)th output of second optical splitter 706 via a respective one of N/2 waveguides 724-726. Although not shown for purposes of clarity, the first group of optical modulators 708-710 can further include any number of additional optical modulators similar to optical modulators 708 and 710, as indicated by the ellipsis (“ . . . ”) symbol. Although not shown for purposes of clarity, the second group of optical modulators 712-714 can further include any number of additional optical modulators similar to optical modulators 712 and 714, as indicated by the ellipsis (“ . . . ”) symbol. As in other embodiments described above, laser 702, optical splitters 704 and 706, optical modulators 708-714, and waveguides 716-726 can be integrated on a monolithic semiconductor substrate 728, such as InP. It can be noted that each of optical splitters 704 and 706 receives a beam having a CW power P, where laser 702 has a total power of 2 P. Accordingly, each output of each of optical splitters 704 and 706 provides a beam having a power 2 P/N.

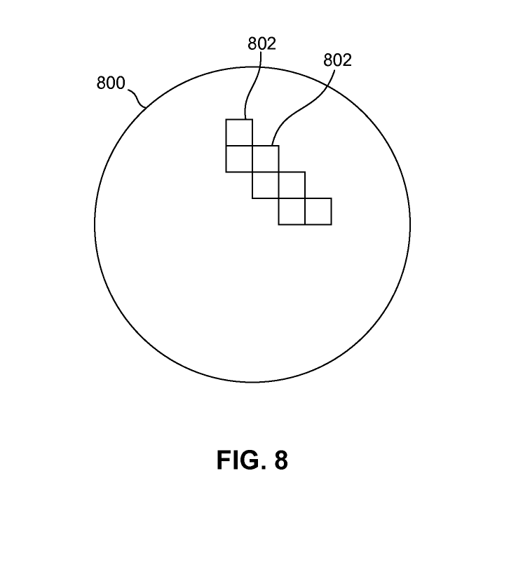

As illustrated in FIG. 8, a multiplicity of parallel optical transmitters 802 (representing any one of the above-described parallel optical transmitters 500, 600 or 700) can be fabricated simultaneously on a semiconductor wafer 800 using fabrication techniques well known in the art. Wafer 800 can be diced in the conventional manner to separate optical transmitters 802 (i.e., monolithic integrated circuits) from each other.

One or more illustrative embodiments of the invention have been described above. However, it is to be understood that the invention is defined by the appended claims and is not limited to the specific embodiments described.

What is claimed is:

1. A parallel optical transmitter, comprising:
a dual-facet continuous-wave laser having a first facet output and a second facet output;
a first optical splitter having an input coupled to the first facet output;
a second optical splitter having an input coupled to the second facet output;
a first optical modulator having an electrical input and having an optical input coupled to a first output of the first optical splitter;
a second optical modulator having an electrical input and having an optical input coupled to a second output of the first optical splitter;
a third optical modulator having an electrical input and having an optical input coupled to a first output of the second optical splitter; and
a fourth optical modulator having an electrical input and having an optical input coupled to a second output of the second optical splitter.

2. The parallel optical transmitter of claim 1, wherein the laser, first optical splitter, second optical splitter, and the first through fourth optical modulators are integrated on a monolithic semiconductor substrate and interconnected by optical waveguides on the substrate.

3. The parallel optical transmitter of claim 1, wherein the laser is substantially balanced.

4. The parallel optical transmitter of claim 1, wherein each of the first and second optical splitters has a splitting ratio of 1-to-2.

5. The parallel optical transmitter of claim 1, wherein each of the first and second optical splitters comprises a multimode interference coupler.

6. The parallel optical transmitter of claim 1, wherein each of the first through fourth optical modulators comprises an electro-absorption modulator.

7. The parallel optical transmitter of claim 1, wherein each of the first through fourth optical modulators comprises a Mach-Zehnder modulator.

8. The parallel optical transmitter of claim 1, further comprising:
a third optical splitter having an input coupled to a first output of the first optical splitter;
a fourth optical splitter having an input coupled to a second output of the first optical splitter;
a fifth optical splitter having an input coupled to a first output of the second optical splitter;
a sixth optical splitter having an input coupled to a second output of the second optical splitter;
a fifth optical modulator having an electrical input and having an optical input coupled to a second output of the third optical splitter;
a sixth optical modulator having an electrical input and having an optical input coupled to a second output of the fourth optical splitter;
a seventh optical modulator having an electrical input and having an optical input coupled to a second output of the fifth optical splitter; and
an eighth optical modulator having an electrical input and having an optical input coupled to a second output of the sixth optical splitter;
wherein the optical input of the first optical modulator is coupled to a first output of the third optical splitter, the optical input of the second optical modulator is coupled to a first output of the fourth optical splitter, the optical input of the third optical modulator is coupled to a first output of the fifth optical splitter, and the optical input of the fourth optical modulator is coupled to a first output of the sixth optical splitter.

9. The parallel optical transmitter of claim 8, wherein the laser, the first through fourth optical splitters, and the first through eighth optical modulators are integrated on a monolithic semiconductor substrate and interconnected by optical waveguides on the substrate.

10. The parallel optical transmitter of claim 8, wherein the laser is substantially balanced.

11. The parallel optical transmitter of claim 8, wherein each of the first through sixth optical splitters has a splitting ratio of 1-to-2.

12. The parallel optical transmitter of claim 8, wherein each of the first through eighth optical modulators is an electro-absorption modulator.

13. The parallel optical transmitter of claim 8, wherein each of the first through eighth optical modulators is a Mach-Zehnder modulator.

14. A parallel optical transmitter having N channels, where N is a power of two greater than or equal to four, the parallel optical transmitter comprising:
a dual-facet continuous-wave laser having a first facet output and a second facet output;
N−2 optical splitters arranged in a binary tree configuration, each optical splitter having no more than one optical input and no more than two optical outputs and having a splitting ratio of 1-to-2, a first one of the N−2 optical splitters having an input coupled to the first facet output, a second one of the N−2 optical splitters having an input coupled to the second facet output; and
N optical modulators, each optical modulator having an electrical input and having an optical input coupled to no more than one optical output of no more than one of the N−2 optical splitters.

15. The parallel optical transmitter of claim 14, wherein the laser, the N optical modulators, and the N−2 optical splitters are integrated on a monolithic semiconductor substrate and interconnected by optical waveguides on the substrate.

16. The parallel optical transmitter of claim 14, wherein the laser is substantially balanced.

17. The parallel optical transmitter of claim 14, wherein each of the N optical modulators is an electro-absorption modulator.

18. The parallel optical transmitter of claim 14, wherein each of the N optical modulators is a Mach-Zehnder modulator.

19. A parallel optical transmitter having N channels, comprising:
a dual-facet continuous-wave laser having a first facet output and a second facet output;
a first optical splitter having an input coupled to the first facet output and having a splitting ratio of 1-to-N/2;
a second optical splitter having an input coupled to the second facet output and having a splitting ratio of 1-to-N/2;
a first group of exactly N/2 optical modulators, each having an electrical input and having an optical input coupled to one of N/2 outputs of the first optical splitter; and
a second group of exactly N/2 optical modulators, each having an electrical input and having an optical input coupled to one of N/2 outputs of the second optical splitter.

20. The parallel optical transmitter of claim 19, wherein the laser is substantially balanced and wherein the laser, the first and second groups of optical modulators, and the first and second optical splitters are integrated on a monolithic semiconductor substrate and interconnected by optical waveguides on the substrate.
